(19) United States
(12) Patent Application Publication
(10) Pub. No.: US 2025/0324111 A1
(43) Pub. Date: Oct. 16, 2025

(54) REPLACEMENT DECISIONING IN ZERO-SLATE FOR STREAMING PLATFORMS

(71) Applicant: M/S. Amagi Media Labs Pvt. Ltd, Bangalore (IN)

(72) Inventors: Baskar Subramanian, Bangalore (IN); Sashidhar Bangar, Bengaluru (IN); Veeresh Ashok Sanagoudar, Layout (IN); Santosh Padmanabha Hegde, Uttara Kannada (IN); Srinidhi Srinivasmurthy, Mysuru (IN); Koyyalamudi Rama Subhrahmanyam, Bengaluru (IN)

(73) Assignee: M/S. Amagi Media Labs Pvt. Ltd, Bangalore (IN)

(21) Appl. No.: 19/177,526

(22) Filed: Apr. 12, 2025

Related U.S. Application Data
(60) Provisional application No. 63/633,478, filed on Apr. 12, 2024.

(51) Int. Cl. H04N 21/234; H04N 21/2187; H04N 21/81

(52) U.S. Cl. CPC H04N 21/23424; H04N 21/2187; H04N 21/812

(57) ABSTRACT

A system, computer-implemented method and computer program product for Replacement Decisioning within a Zero-Slate system for Linear TV having (a) a module to fetch replacement content, (b) a module to prepare media, (c) a module for macros replacement, (d) configuration service, (e) a replacement segment server and (f) load balancer to reduce ad-fatigue for users.

### CROSS REFERENCE TO RELATED APPLICATIONS

This application claims the benefit of and priority on U.S. Provisional Patent Application No. 63/633,478 having a filing date of 12 Apr. 2024.

### FIELD OF THE INVENTION

This invention relates to a Replacement Decisioning System within a zero-slate system within Free Ad-supported Streaming TV (FAST).

### BRIEF DESCRIPTION

This patent describes a system and method for replacement decisioning within a zero slate system for streaming platforms.

### BACKGROUND AND PRIOR ART

Prior art shares a common theme centered on enhancing the viewing experience through personalized, targeted, and dynamic media content delivery. They achieve this by utilizing advanced techniques to selectively deliver tailored advertisements or alternative content to viewers based on user profiles, viewing habits, demographics, and available bandwidth or network conditions. Optimizing content delivery by strategically substituting default advertisements or content segments with personalized, relevant alternatives, using metadata or dynamic updating mechanisms to enable precise identification, selection, and seamless insertion of media, achieves the goal. The challenge of delivering personalized content efficiently, often involving transitions between multicast and unicast streams, dynamic adaptation of media segments through metadata, and precise control over advertisement frequency to maximize viewer engagement is overcome in parts by the state of the art that consistently employs mechanisms for viewer-specific targeting and automated tracking of viewer interactions or preferences to enhance the effectiveness of media delivery.

U.S. Pat. No. 9,032,433 titled “Personalized ad insertion during start over service” discloses a method and apparatus for inserting targeted advertisements into video streams during a start-over viewing service. When a viewer requests to restart a multicast video stream after its original start time, a cached copy of the requested content is retrieved and forwarded toward the viewer. The system monitors the cached stream for a default advertisement splice-in point, then seamlessly replaces it with a targeted advertisement delivered through a unicast stream, which the viewer's device selects without explicit user action. Targeted ads are selected based on viewer profiles, allowing personalized advertising. This innovation enhances IPTV services by efficiently integrating personalized ads into multicast content without requiring complex client-side mechanisms. Independent claims specifically describe the process of detecting splice points, inserting unicast ads, and instructing client devices to switch streams seamlessly, ensuring personalized ad delivery without disrupting user experience.

US20110119703 titled “Method and apparatus for delivering SDV unicast programming with targeted advertising on a bandwidth-available basis” discloses an improved approach to Switched Digital Video (SDV) systems that selectively delivers targeted ads based on bandwidth availability. An SDV manager coordinates sessions requested by subscriber terminals, continuously monitoring unused network bandwidth. If sufficient bandwidth is available, subscribers receive individually targeted advertisements through unicast SDV streams. When bandwidth is constrained, subscribers instead receive multicast streams featuring group-targeted advertising. The system intelligently balances personalized ad delivery and network resource management, reducing infrastructure strain and avoiding the need for additional modulators. Independent claims describe determining bandwidth availability, selecting subscribers for unicast ad delivery, and seamlessly transitioning between multicast and unicast streams. This invention provides efficient bandwidth usage while ensuring subscribers receive targeted, relevant advertising, significantly optimizing SDV advertising capabilities.

U.S. Pat. No. 11,038,938 titled “Methods and apparatus for providing alternative content” discloses a method for dynamically updating Media Presentation Description (MPD) information within DASH-based streaming systems to insert targeted or alternative content. Initially, client devices receive default MPD information identifying content segments. During playback, clients receive an in-band trigger prompting a request for updated MPD information. The updated MPD dynamically replaces original segments with targeted or locally relevant content. Rather than continuously polling for MPD updates, the system strategically uses these triggers, reducing network traffic. Independent claims specifically address dynamically updating MPD data, utilizing in-band trigger messages to request alternative content, and switching operational modes to optimize update efficiency. This method enhances streaming efficiency and content personalization by intelligently managing alternative content delivery and MPD updates, ensuring viewers receive targeted, relevant programming without unnecessary network overhead.

U.S. Pat. No. 9,037,482 titled “Method and system for optimizing the viewing of advertising” discloses methods for controlling the frequency of ad displays to viewers, ensuring an optimal viewing experience. The system tracks how often each advertisement is played and compares it against an optimal viewing frequency tailored to individual viewer behaviours or profiles. Once an ad reaches its optimal frequency threshold, it is automatically replaced with another queued advertisement. The optimum frequency can dynamically adapt based on user interactions such as channel-switching habits or direct viewer feedback. The advertisements and their replacements can be digitally broadcast or pre-stored locally on a client device. Independent claims specifically describe methods for determining ad playback frequency, monitoring viewer interactions, and dynamically managing advertisement substitution. The invention helps advertisers maintain viewer interest by preventing overexposure and ad fatigue, enhancing overall ad campaign effectiveness through precise, viewer-specific targeting and frequency control.

U.S. Pat. No. 8,230,343 titled “Audio and video program recording, editing and playback systems using metadata” discloses a system that uses metadata to allow viewers greater control over storage, editing, and playback of broadcast programming. Metadata, generated at a centralized or local user site, identifies and describes segments of broadcast content. The system leverages this metadata to selectively record desired segments, reorganize playback sequences, remove unwanted material, or insert additional relevant information. Metadata further includes descriptive text and segment attributes to enable powerful searching, sorting, and selection capabilities. Users may directly select segments for playback using intuitive metadata-based segment guides. Independent claims describe the methods and apparatus for identifying, associating, and utilizing metadata with specific broadcast segments to improve viewer interaction. This innovation significantly enhances the viewing experience by providing greater personalization, flexibility, and intuitive navigation through large volumes of broadcast content, offering tailored playback experiences based on detailed content descriptions.

U.S. Pat. No. 8,855,469 titled “Method for remotely controlling a streaming media server with a pause and resume functionality” discloses a method and system enabling pause and resume features for streaming media playback on mobile devices. The method includes receiving streaming content on a mobile device, initiating playback, and pausing playback based on various triggers, such as user actions, incoming notifications, or network conditions. The system allows seamless resumption of media content from the paused point, potentially inserting targeted advertisements upon resume. Playback parameters during pause and resume events are tracked, optimizing future content delivery and ingestion processes. Independent claims highlight initiating streaming, managing pauses triggered by device-specific, network-based, or user-driven events, and resuming playback from precisely the paused position. This invention enhances media consumption by granting users flexible playback control, efficient bandwidth management, targeted advertising placement, and seamless media transitions across different network types and devices, significantly improving user experience in streaming environments.

Our invention proposes a system and method for Replacement Decisioning within a Zero-Slate Linear TV system interacts with a media preparation service, one or more replacement engines, and an Elastic Playout module that includes modules for fetching replacement content, preparing media, performing macro replacements, a configuration service, a replacement segment server, and a load balancer. The replacement engines may encompass Ad Servers, content replacement modules, live stream handlers, and graphics modules. A corresponding method for Replacement Decisioning involves the Elastic Playout System (EPS) requesting replacement content based on channel-ID, user and device details, EPG information, and trigger-type, subsequently performing system checks, recognizing appropriate handlers, parsing standardized ad-network responses, and delivering transcoded ad asset segments for stitching.

### BRIEF DESCRIPTION OF THE DRAWINGS

FIG. 1 shows the overall system for Zero Slate linear TV.

FIG. 2 shows the Replacement Decisioning Engine and how it interacts with options.

FIG. 2a shows the Replacement Decisioning Engine in more detail.

FIG. 3 shows the use case for Elastic Playout based on EPG.

FIG. 3a shows an example of the stream influenced by the replacement decisioning engine.

FIG. 4 shows the method for Replacement Decisioning.

### DETAILED DESCRIPTION OF PREFERRED EMBODIMENTS

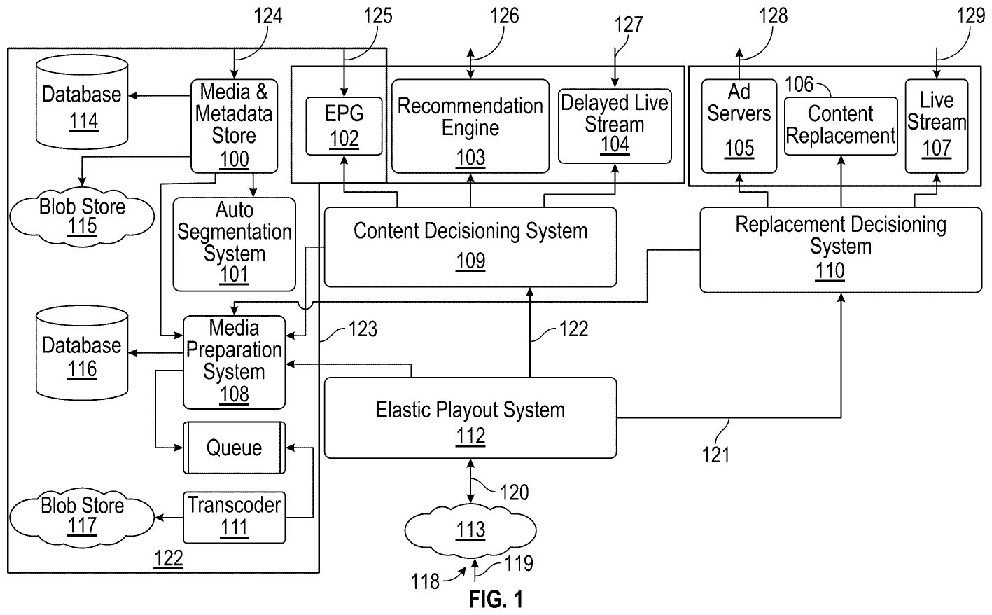

FIG. 1 shows the overall system for Zero Slate Linear TV further comprising the modules for Media Preparation, Auto segmentation, Elastic Playout, Content Decisioning and Replacement Decisioning. There are several components including the Ingest Media 100, EPG ingest 101, one or more recommendation engines 102, input live streams 103, an Ad network 104, and an input live stream 105. 101 interacts with a media and metadata store 107, which works with a database 106, a blob store 115, an auto-segmentation system 116 and a media preparation system 120 that interacts with the elastic layout system 124 and also with a database 119 and a queue 123. A transcoder 126 interacts with the queue 123 and a blob store 125. The EPG ingest 101 interacts with a global EPG 108, which receives inputs from a content decisioning system 117. One or more recommendation engines 102 interact with one or more third-party or in-house recommendation engines 109, which also interact with the content decisioning system 117. An input live stream 103 interacts with a delayed global live stream 110 which also interacts with the content decisioning system 117. There is an ad network 104 which interacts with one or more third-party ad servers 112, a content replacement block 113 and an input live stream 105 that interacts with a live stream 114. All these components 112, 113 and 114, interact with the replacement decisioning engine 118. One or more users 128 with Channel_IDs interact with a global content distribution network (CDN) 127 which works with an elastic playout system 124 in fetching manifests from their origin 130

The Elastic Playout System 124 converts an array of media assets to a live stream works with the Media Preparation System 120 sending segmented content segments for media 121, the Content Decisioning System 117 where it gets program content, Channel_ID, pass user's details (IP, UserAgent, DeviceID, etc.) 122 and the Replacement Decisioning System 118 where it sends replacement content including Channel_ID, Pass User's Details (IP, User Agent, Device ID, etc.) 131.

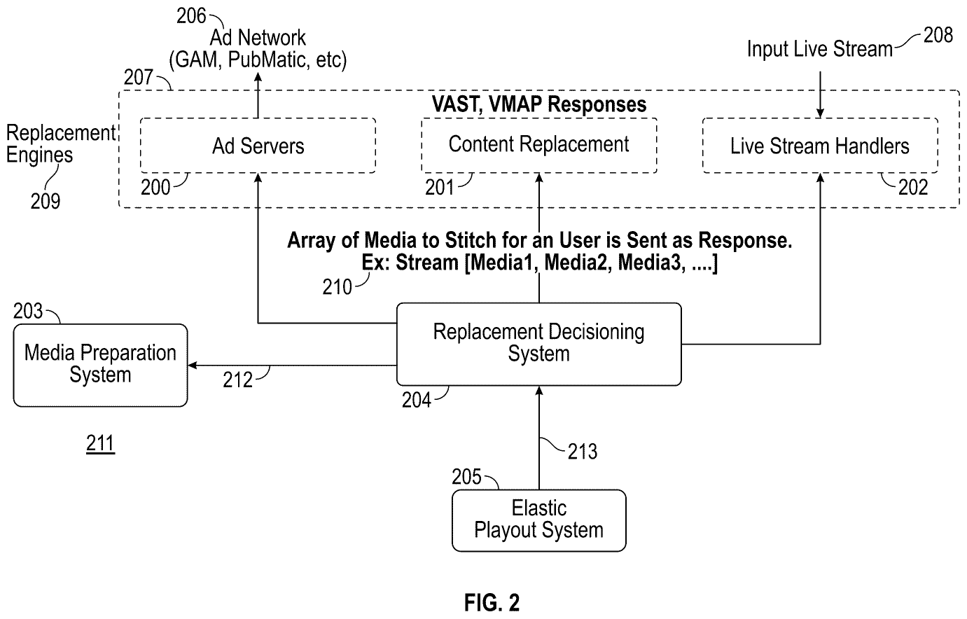

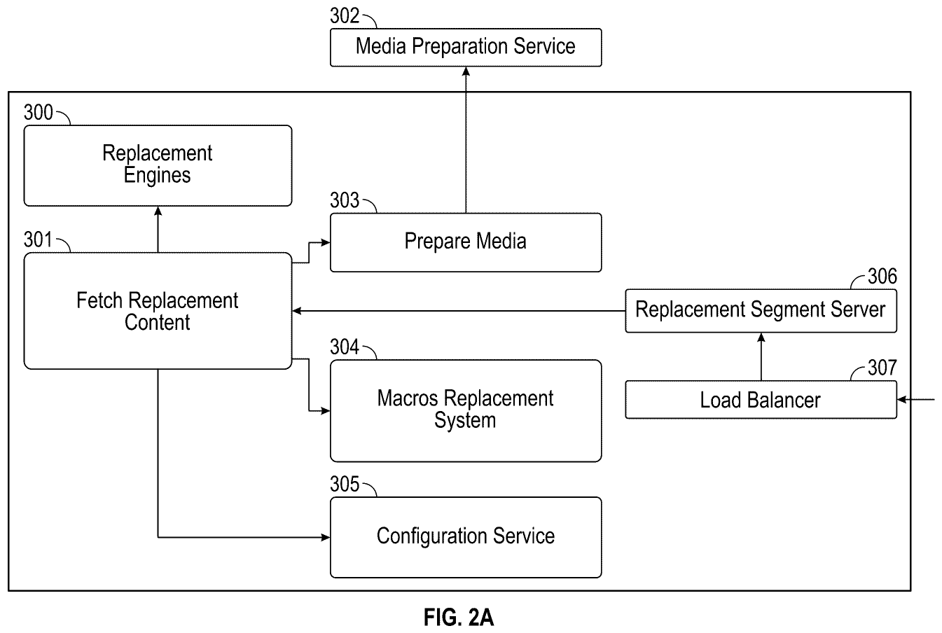

FIG. 2 shows the Replacement Decisioning Engine (RDE) 204, which returns an array of media assets 210, and how it interacts with options including those provided by ad servers, content replacement engines, live stream handlers and graphics engines. The ad servers 200 interact with one or more ad networks (GAM, PubMatic, etc.) 206 and parse VAST, VMAP or other protocols and converts them to an internally standardized format. The content replacement block 201 parses responses from external content providers into an internal standardized format. Live stream handlers 202 parse live HLS, DASH or equivalent sources 208 into an internal standardized format. The RDE 204 sends an array of media to stitch for a user 210. An example Stream would have [Media1, Media2, Media3 . . . ]. The RDE further interacts with the media preparation module 203 to get or enqueue where the parameters include channel ID and streams 212. The RDE also interacts with the Elastic Playout System 205 to exchange replacement content including a marker type for each kind of replacement (ads, content, live stream), channel IDs, user details, etc. 213.

FIG. 2a shows the Replacement Decisioning Engine in more detail. It comprises one or more replacement engines 300, exemplarily, ads, content, livestream, graphics and a media preparation service. Within it, it contains modules to fetch replacement content 301, prepare media 303, replace macros 304, a configuration service 305, a replacement segment server 306 and a load balancer 307. The module to fetch replacement content 301 bases its decisions on the channel configuration wherein this module determines the strategy to make replacement engine calls. It further utilizes sequence calls and dynamic pod splits. The module to prepare media 303 normalizes ads and content assets to the channels transcoding profile. The module to replace macros 304 replaces the macros values in the ad-tag with the user, device and EPG details. The replaced values are then used by the final replacement engines. The configuration service 305 stores channel to ad-tag, live URLs configuration, etc. The replacement segment server 306 serves an array of segments with trackers and other metadata. Inputs to this module include Channel_ID, Replacement trigger type (ads, content, live, etc.), Duration of replacement in milliseconds, user identifiers, EPG details (Genre of the content that is getting watched,), channel identifiers ( ) device identifiers (deviceID, device make, etc.). The outputs include an array of segments to insert or replacement. The primary functionality includes using the Channel_ID, and trigger type, determine which replacement engine to use, calling the corresponding replacement engine, passing the relevant parameters that are expected by them and getting the responses from replacement engines and checks with media preparation service if the assets are already transcoded. Media preparation service enqueues the not transcoded assets for transcoding. For already transcoded assets, it returns an array of segments. The order of segments matches the order of the assets that are sent to it.

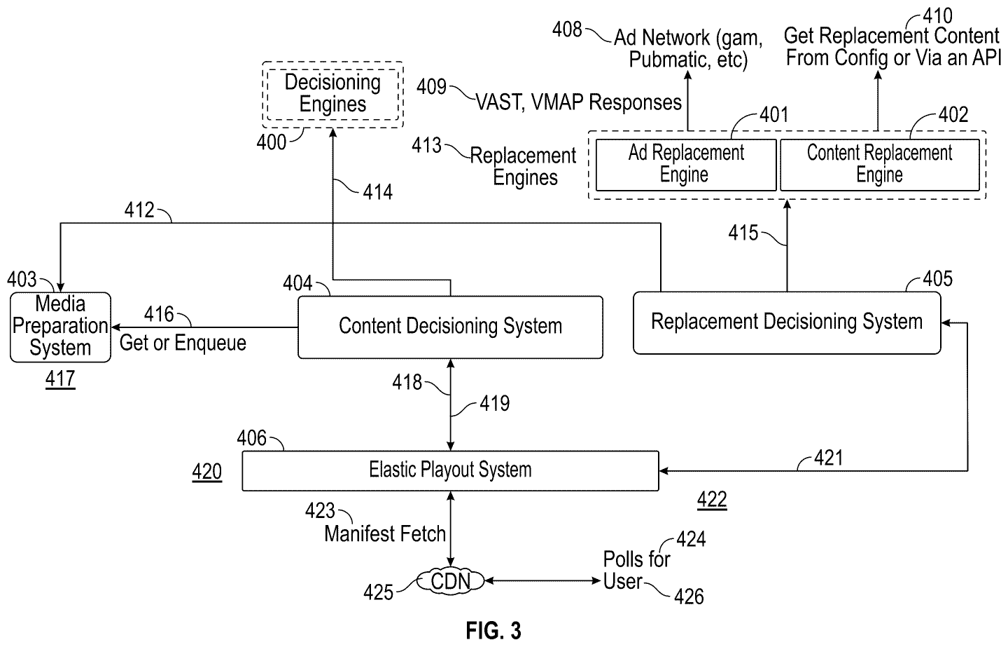

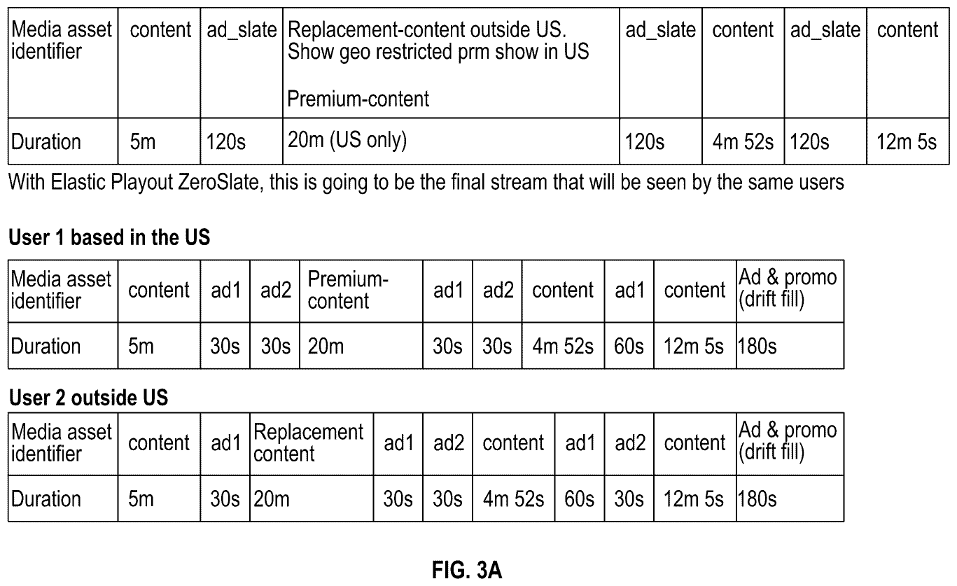

FIG. 3 shows the Replacement Decisioning Engine in more detail. The modules in this include one or more decisioning engines 411 which could be any of EPG, Recommendation Engines or Live streams, one or more replacement engines 413, a media preparation system 403, a content decisioning system 404, a replacement decisioning system 405, an elastic playout system 406 and a content distribution network (CDN) 425. We describe them in more detail below.

The Decisioning Engines 400 ingest and onboard content 407 from one or more EPGs, Recommendation Engines or Live Streams. This service 400 consumes the EPG schedules that are uploaded by the customer and stores it into a timestamp to asset mapping. When the content decisioning engine asks for the content to play, it uses the wall clock time that is sent as input to return the array of assets to play starting from the wall clock time. This service also takes as input an array 414 of media to stitch for a user is sent as response. Ex: stream [media1, media2, media3, . . . ].

The replacement engines 413 comprise of an ad replacement engine 401 and a content replacement engine 402. They obtain an Array of media to stitch for a user is sent as response. Ex: stream [media1, media2, media3, . . . ] 415 from the replacement decisioning system 405. The ad replacement engine 401 requests ad servers for personalized ads for a user. It passes user details, device details, EPG details, etc. to them to get personalized ads interacts with one or more ad networks (including GAM, PubMatic, etc.) 408 via VAST/VMAP responses 409. The content replacement engine 402 picks pre-defined content based on the channel's config or calls an API to get the replacement content. The response is standardized and returned back. 402 gets replacement content from configured values or via an API 410.

The media preparation engine 403 interacts with the replacement decisioning engine 405 by obtaining one or more return segments for a media if it is already transcoded media: [media_s1, media_s2, media_s3, for all the transcoding profiles of the channel 412. 403 further interacts with the content decisioning system 404 by obtaining for transcoding parameters including channel ID, [Media], etc. 416.

The content decisioning engine 404 exchanges an array of segments to stitch for a user is sent as response ex stream [media1_s1, media1 s2, media2_s1, media2_s2, media3_s1, media3_s2, media3_s3 . . . ] 419 from the Elastic Playout System (EPS) 406 and a ‘Get program content. Channel_ID, pass user's details (ip useragent, deviceid, etc.), device detail-explain directionality please’ 418. The EPS 406 further exchanges a ‘get replacement content. Channel_ID, pass user's details (ip, useragent, deviceid, etc.), device details, epg details, etc.’ 421 and an Array of replacement segments to stitch for a user is sent as response ex stream [media1_s1, media1 s2, media2_s1, media2_s2, media3_s1, media3_s2, media3_s3 . . . ] 422. The EPS further contains a User's segment buffer user1: [media1_s1, media1_s2, media2_s1, media2 s2, media3 s1, ad1_s1, ad1_s2, media3_s2, media3_s3, . . . ] 420.

A content distribution network (CDN) 425 interacts with polls for manifest updates 424 and the EPS 406 and performs a manifest fetch for a user 423.

FIG. 3a shows an example of the stream influenced by the replacement decisioning engine. While our example only shows the replacement of ads, in future embodiments, we can also have the content replaced by the replacement decisioning engine. In this example, we see that there is geographically tagged (premium) content that only targeted users are able to view.

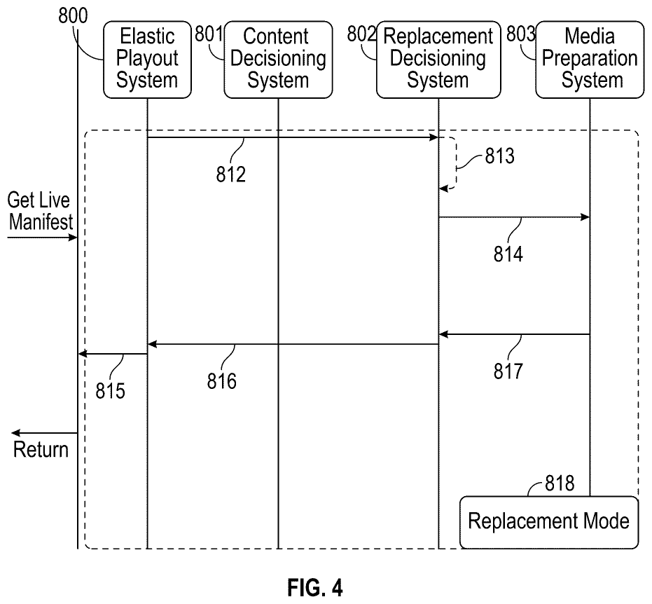

FIG. 4 discloses a computer-implemented method for Replacement Decisioning System within a zero-slate, within Free Ad-supported Streaming TV (FAST) for creating personalized linear channels with the ability to avoid slates/filler content during ad-breaks and manage viewer-specific ad loads with (a) a Media Preparation System 803, (b) a content decisioning system (CDS) 801, (c) an elastic playout system (EPS) 800, and (d) a replacement decisioning system (RDS) 802, capable of operating in (i) content mode and (ii) replacement mode. The method has the following steps—

In content mode 811, the user requests EPS for a live manifest 804. The EPS requests CDS 805 for assets to play in the present time window. The CDS talking to a decisioning engine 806 to get the corresponding assets. The CDS gets one or more corresponding segments from the Media Preparation System 807. The Media Preparation System responding 808 with one or more transcoded segments for the request 807. The CDS responds 809 with segments to the EPS in response to 805. Finally, the EPS builds a new manifest for the user request 804 and responds with the live manifest 810.

In replacement mode 818, the method changes to the user requesting EPS for a live manifest 804 and the EPS requesting RDS 812 for assets to play in the present time window. The RDS talking to the EPS 813 to get the corresponding assets. The RDS gets one or more corresponding segments from the Media Preparation System 814. The Media Preparation System responding 817 with one or more transcoded segments for the request 814. The RDS responds 816 with segments to the EPS in response to 812 and finally, the EPS builds a new manifest for the user request 804 and responds with the live manifest 810.

This figure also shows the overall method for the present invention including the creation of personalized ad breaks, means to shape ad breaks to cater to non-availability of ads for certain users, means to reset the live media stream to match the original EPG module, means for signal reset to reset streaming selectively for specific assets using in band SCTE signaling, means to declare a reset timeline as a configuration parameter where if the drift time exceeds a pre-configured duration then a reset is triggered. Means to declare a reset timeline as a configuration parameter where if the drift time exceeds a pre-configured duration, it triggers a reset. A drift timeline is maintained encapsulating the drift between a specific user and the corresponding original EPG timeline. The method can further autofill the drift duration with interesting content from the content owner's catalog.

This method works with four components, the Elastic Playout System (EPS) 800, the Content Decisioning System 801, the replacement decisioning system 802, and the media preparation system 803. Each component has a set of inputs and outputs.

The EPS 800 receives a live manifest for the channel manifest for User requests the channel the manifest every X seconds as long as the their session is active 804. The EPS 800 also receives a Return array of replacement segments to stitch which matches the channel's transcoding spec 816 from the Replacement Decisioning Engine 802. The outputs of the EPS include a ‘Get live manifest for the channel’ 805, a ‘Get replacement content for this user and channel’ 812, a Return live stream HLS or DASH manifest for the user 810 and a Return live stream HLS or dash manifest for the user with replaced content 815.

The Content Decisioning System 801 has two inputs a Get live manifest for the channel 805 and a Return array of segments for the content assets matching the channel's transcoding profiles 808 and two outputs-a Get segments from the content assets matching the channel's transcoding profiles 807, a Return array of segments to stitch for channel's transcoding profiles including the replacement markers 809.

The Replacement Decisioning System 802 has two inputs a Get replacement content for this user and channel 812, a Return array of segments for the content assets matching the channel's transcoding profiles 817 and two outputs a Get segments from the ad assets matching the channel's transcoding profiles 814, a Return array of replacement segments to stitch which matches the channel's transcoding spec 816.

The Media Preparation System 803 has two inputs-a Get segments from the content assets matching the channel's transcoding profiles 807, a Get segments from the ad assets matching the channel's transcoding profiles 814 and two outputs-a Return array of segments for the content assets matching the channel's transcoding profiles 808, a Return array of segments for the content assets matching the channel's transcoding profiles 817.

We also disclose a non-transitory, machine-readable storage medium having stored there on a computer program for replacement decisioning within zero-slate, within Free Ad-supported Streaming TV (FAST) for creating personalized linear channels with the ability to avoid slates/filler content during ad-breaks and manage viewer-specific ad loads, the computer program comprising a set of instructions for causing a machine to perform the steps of the method described in FIG. 4.

We also provide a legend below with part numbers and descriptions, detailing the attributes in each exchange in many cases, for clarity, completeness and conciseness.

### Legend Below with Reference Numerals and Descriptions

| Figure | Part | Description |
|---|---|---|
| 1 | 100 | Ingest Media & Metadata Store |
| | 102 | EPG Ingest |
| | 103 | Recommendation Engines |
| | 104 | Live Stream |
| | 105 | Ad Network |
| | 106 | Input Live Stream |
| | 107 | Database from media & metadata store |
| | 108 | media & metadata store from ingest media |
| | 109 | EPG from EPG Ingest |
| | 110 | Recommendation Engines |
| | 111 | Delayed Live Stream from Input Live Stream |
| | 112 | Elastic Playout System (Regional) Converts |
| | | Array of Media Assets to a Live Stream |
| | 113 | Ad Servers from Ad network |
| | 114 | Describes Content Replacement |
| | 115 | Live Stream from Input Live stream |
| | 116 | Blob Store (Global) from Media & Metadata store |
| | 117 | Auto Segmentation System from Media & Metadata store |
| | 118 | Content Decisioning System |
| | 119 | Replacement Decisioning System |
| | 120 | Database from Media Preparation System |
| | 121 | Content Decisioning System (Global) Returns Array |
| | | of media assets from Recommendation engine |
| | 122 | Get Segmented Content Segments for Media |
| | 123 | Get Program Content. Channel_ID Pass User's details (IP, |
| | | UserAgent, DeviceID. Etc) |
| | 124 | Queue (Regional) from transcoder |
| | 125 | Elastic Playout System (Regional) Covverts Array |
| | | of Media Assets to alive stream |
| | 126 | Blob Store |
| | 127 | Transcoder |
| | 128 | CDN |
| | 129 | Users |
| | 130 | Fetch Manifest |
| | 131 | Fetch Manifest from Origin |
| | 132 | Get Replacement content channel id pass users |
| | | details IP user agent device ID etc. |
| 2 | 200 | Ad Servers Parses VAST, VMAP or Other Protocols |
| | | and Converts into an Internal Standardized Format |
| | 201 | Content Replacement Parses Response |
| | | from External Content Providers into |
| | | Internal Standardized Format |
| | 202 | Live Stream Handlers Parses the Live |
| | | HLS, Dash or Equivalent Sources and Bring |
| | | them into Internal Standardized Format |
| | 203 | Describes Replacement Decisioning System |
| | | (Regional) Returns Array of Media Assets |
| | 204 | Replacement Decisioning System |
| | 205 | Ad Network (GAM, PubMatic, etc) |
| | 206 | VAST, VAMP Responses |
| | 207 | Input Live Stream |
| | 208 | Replacement Engines |
| | 209 | Array of Media to Stitch for a |
| | | User is Sent as Response. Ex: Stream |
| | | [Media1, Media2, Media3, . . . ] |
| | 210 | Checks if a media is already transcoded. Else it |
| | | enqueues in transcoding queue for transcoding. |
| | 211 | Get or Enqueue for Transcoding. |
| | | Parameter: Channel D, [Media . . . ] |
| | 212 | Get Replacement Content |
| | | (Replacement Marker Type (ads, Content, |
| | | Live), Chanel User Details |
| | | (IP, Useragent, DeviceID, etc)} |
| 2A | 300 | Replacement Engines |
| | 301 | Fetch Replacement Content |
| | 302 | Media Preparation Service |
| | 303 | Prepare Media |
| | 304 | Macros Replacement System |
| | 305 | Configuration Service |
| | 306 | Replacement Segment Server |
| | 307 | Load Balancer |
| 3 | 400 | Epg service |
| | 401 | Ad replacement |
| | 402 | Content replacement engine |
| | 403 | Media preparation system |
| | 404 | Content decisioning system |
| | 405 | Replacement decisioning |
| | 406 | Elastic playout system |
| | 407 | EPG ingest |
| | 408 | Ad network (gam, pubmatic, etc) |
| | 409 | VAST, VAMP Responses |
| | 410 | Get replacement content from configure or via an API |
| | 411 | Decisioning engine. |
| | 412 | Return segments for a media |
| | | if it is already transcoded. Média: |
| | | [media st, media_s2, media s3 for all the |
| | | transcoding profiles of the channel |
| | 413 | Replacement engines |
| | 414 | Array of media to stitch for a user is sent as response. |
| | | Ex: stream [media1, media2, media3, . . . ] |
| | 415 | Array of media to stitch for a user is sent as |
| | | response. Ex: stream [media1, media2, media3, . . . ] |
| | 416 | Get or enqueue |
| | 417 | Checks if a media is already transcoded. |
| | | Else it enqueues in transcoding queue |
| | | for transcoding. |
| | 418 | Get program content. Channel_ID, pass user's |
| | | details (ip useragent, deviceid, etc), device details |
| | 419 | Array of segments to stitch |
| | | for a user sent as response. Ex: stream |
| | | [media1_s1, mediat s2, |
| | | media2 s1, media2_s2, media3 s1, |
| | | media3_s2, media3 s3, . . . ] |
| | 420 | User's segment buffer user1: |
| | | [media1_s1, media1 s2, media2 1, |
| | | media2 s2, media3 s1, ad1 s1, |
| | | ad1 s media3 s2 media3 s3, . . . ] |
| | 421 | Get program content. Channel_ID, pass user's |
| | | details (ip useragent, deviceid, etc), device details |
| | 422 | Array of replacement segments to stitch |
| | | for a user is sent as response. Ex: stream [media1_s1, |
| | | media1 82,media2 s1, media2 s2, |
| | | medias st, media3_s2, media3_s3 |
| | 423 | Manifest fetch |
| | 424 | Polls for manifest updates every |
| | | x seconds for a channel |
| | 425 | CDN |
| | 426 | User |
| 4 | 800 | Elastic Playout system |
| | 801 | Content Decisioning System |
| | 802 | Replacement Decisioning System |
| | 803 | Media Preparation System |
| | 804 | Get live manifest |
| | 805 | Get live manifest for the channel |
| | | Fetch content form EPG, |
| | | Recommendation pr Delayed live |
| | 807 | Get segments from the content assets |
| | | matching the channel's transcoding profiles |
| | 808 | Return live stream HLS or Dash manifest for the user |
| | 809 | Return array of segments to stich for channel's |
| | | transcoding profiles including the replacement markers |
| | 810 | Return array of segments for the content assets |
| | | matching the channel's transcoding profile |
| | 811 | Content mode |
| | 812 | Get replacement content for this user and channel |
| | 813 | Fetch Replacement content from ad-servers |
| | 814 | Get segments from the ad assets matching the channel's |
| | | transcoding profiles |
| | 815 | Return live stream HLS or Dash manifest |
| | | for the user with replaced content |
| | 816 | Return array of replacement segments to stich |
| | | which matches the channel's transcoding spec |
| | 817 | Return array of segments for the content assets |
| | | matching the channel's transcoding profiles |
| | 818 | Replacement mode |

What is claimed is:

1. A system for Replacement Decisioning within a Zero-Slate system for Linear TV comprising (a) One or more replacement engines 300, (b) a module to fetch replacement content 301, (c) a macros replacement system 304, (d) a configuration service 305, a replacement segment server 306 and (e) a load balancer 307 interacting with a media preparation service 302, wherein:
a) one or more replacement engines 300;
b) the module to fetch replacement content 301 bases its decisions on the channel configuration wherein this module determines the strategy to make replacement engine calls and further utilizes sequence calls and dynamic pod splits;
c) the module to prepare media 303 normalizes ads and content assets to the channels transcoding profile;
d) the module to replace macros 304 replaces the macros values in the ad-tag with the user, device and EPG details such that the replaced values are then used by the final replacement engines;
e) the configuration service 305 stores channel to ad-tag, live URLs configuration, etc.;
f) the replacement segment server 306 serves an array of segments with trackers and other metadata;
g) a load balancer 307;
h) the media preparation engine 403 interacts with (a) the replacement decisioning engine 405 by obtaining one or more return segments for a media if it is already transcoded, for all the transcoding profiles of the channel 412; and (b) with the content decisioning system 404 by obtaining for transcoding parameters 416;
i) the content decisioning engine 404 exchanges an array of segments to stitch for a user 419 from the Elastic Playout System (EPS) 406 and gets program content 418;
j) the EPS 406 exchanges replacement content 421, an Array of replacement segments to stitch 422 and a User's segment buffer 420; and
k) The content distribution network (CDN) 425 interacts with polls for manifest updates 424 and the EPS 406 and performs a manifest fetch for a user 423.

2. The system of claim 1 wherein the ad networks exemplarily include GAM and PubMatic.

3. A computer-implemented method for zero-slate, within Free Ad-supported Streaming TV (FAST) for creating personalized linear channels with the ability to avoid slates/filler content during ad-breaks and manage viewer-specific ad loads with (a) a Media Preparation System 803, (b) a content decisioning system (CDS) 801, (c) an elastic playout system (EPS) 800, and (d) a replacement decisioning system (RDS) 802, capable of operating in replacement mode, comprising the steps of:
a) User requesting EPS for a live manifest 804;
b) EPS requesting RDS 812 for assets to play in the present time window;
c) the RDS talking to the EPS 813 to get the corresponding assets;
d) the RDS getting one or more corresponding segments from the Media Preparation System 814;
e) the Media Preparation System responding 817 with one or more transcoded segments for the request 814;
f) the RDS responding 816 with segments to the EPS in response to 812; and
g) the EPS building a new manifest for the user request 804 and responding with the live manifest 810.

4. The computer-implemented method of claim 3 wherein the CDS talks to a decisioning engine 806 which is an EPG.

5. The computer-implemented method of claim 3 wherein the CDS talks to a decisioning engine 806 which is a Recommendation Engine.

6. The computer-implemented method of claim 3 wherein the CDS talks to a decisioning engine 806 which is a delayed live stream.

7. The computer-implemented method of claim 3 wherein the RDS talks to the EPS 813 where:
a) a replacement engine returns one or more ad assets; or
b) a replacement engine returns one or more replacement content segments; or
c) a replacement engine returns one or more live segments.

8. The computer-implemented method of claim 3 wherein the assets in b) include Channel_ID, user details, device details, EPG details, and trigger-type as inputs.

9. The computer-implemented method of claim 3 wherein the Ad server (a) has interactions exemplarily handled by ad-servers service, (b) the response expected from ad-servers is either VAST or VMAP.

10. The computer-implemented method of claim 3 wherein the EPS 800 further:
a) receives a live manifest for the channel manifest for User requests the channel the manifest every ‘X’ seconds as long as the their session is active 804;
b) receives a ‘Return array of replacement segments to stitch which matches the channel's transcoding spec’ 816 from the Replacement Decisioning Engine 802; and
c) sends a ‘Get live manifest for the channel’ 805, a ‘Get replacement content for this user and channel’ 812, a ‘Return live stream HLS or DASH manifest’ for the user 810 and a ‘Return live stream HLS or DASH manifest for the user with replaced content’ 815.

11. The computer-implemented method of claim 3 wherein the Replacement Decisioning System 802 further:
a) receives a ‘Get replacement content for this user and channel’ 812, a segment from the EPS signaling the replacement engine 813 and ‘a Return array of segments for the content assets matching the channel's transcoding profiles; 817; and
b) sends a ‘Get segments from the ad assets matching the channel's transcoding profiles’ 814, and ‘a Return array of replacement segments to stitch which matches the channel's transcoding spec’ 816.

12. The computer-implemented method of claim 3 wherein the Media Preparation System 803 further:
a) receives ‘a Get segments from the content assets matching the channel's transcoding profiles’ 807, and a ‘Get segments from the ad assets matching the channel's transcoding profiles’ 814; and
b) sends a ‘Return array of segments for the content assets matching the channel's transcoding profiles’ 808 and a ‘Return array of segments for the content assets matching the channel's transcoding profiles’ 817.

13. A non-transitory, machine-readable storage medium having stored there on a computer program for zero-slate, within Free Ad-supported Streaming TV (FAST) for creating personalized linear channels with the ability to avoid slates/filler content during ad-breaks and manage viewer-specific ad loads with (a) a Media Preparation System 803, (b) a content decisioning system (CDS) 801, (c) an elastic playout system (EPS) 800, and (d) a replacement decisioning system (RDS) 802, capable of operating in replacement mode, the computer program comprising a set of instructions for causing a machine to perform the steps of:
a) User requesting EPS for a live manifest 804;
b) EPS requesting RDS 812 for assets to play in the present time window;
c) the RDS talking to the EPS 813 to get the corresponding assets;
d) the RDS getting one or more corresponding segments from the Media Preparation System 814;
e) the Media Preparation System responding 817 with one or more transcoded segments for the request 814;
f) the RDS responding 816 with segments to the EPS in response to 812; and
g) the EPS building a new manifest for the user request 804 and responding with the live manifest 810.
